(19) United States
(12) Patent Application Publication
(10) Pub. No.: US 2005/0144003 A1
(43) Pub. Date: Jun. 30, 2005

(54) Multi-lingual speech synthesis

(75) Inventor: Juha Iso-Sipila, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/730,373

(22) Filed: Dec. 8, 2003

(51) Int. Cl. G10L 13/00

(52) U.S. Cl. 704/269

(57) ABSTRACT

A method for speech synthesis of a word in a first language, comprising dividing the word into a first sequence of pronunciation phonemes in the first language, mapping the first phoneme sequence to a second sequence of pronunciation phonemes in at least one second language, and generating an audio output of the phonemes in the second phoneme sequence using prosody models adapted for the at least one second language. According to this method, an audio output of a word in a first language can be generated by a speech synthesizing engine not having actual support for this language. Instead, the pronunciation phonemes of the word are mapped onto phonemes of at least one second language, for which the speech synthesizing engine does have support.

### FIELD OF THE INVENTION

The invention relates to the area of voice interfaces, and specifically to speech synthesis of a word in a given language. Voice interfaces are used e.g. in communication devices, and in particular in mobile communication devices and personal digital assistants (PDA:s).

### BACKGROUND OF THE INVENTION

A current trend in Automated Speech Recognition (ASR) is towards speaker-independent systems which are capable of handling several different languages. This typically requires extensive research work for each supported language. At the same time, it is often desirable to also include a speech synthesis, or Text-To-Speech (TTS), system, e.g. for generating voice dialing feedback to the user when no user training is required. A TTS system comprises a TTS engine, developed for a specific language and adapted to generate audio output based on a given list of pronunciation phonemes belonging to this language.

Language support of a TTS system (i.e. a new TTS engine) is more difficult to develop than language support for speech recognition, as more phonetics knowledge and speech resources are required. Furthermore, evaluation of a TTS engine is more demanding and more subjective in its nature. Consequently, prior art systems typically support more languages for speech recognition than for TTS.

### SUMMARY OF THE INVENTION

An object of the present invention is to reduce the above mentioned problem, and to provide a cost efficient way to increase the number of languages supported by a TTS system.

Generally, this and other objects are achieved by a method for speech synthesis, a computer program product for performing the method, a speech synthesizer, and a communication device including such a speech synthesizer according to that which is disclosed below.

A first aspect of the invention relates to a method for speech synthesis of a word in a first language, comprising dividing the word into a first sequence of pronunciation phonemes in the first language, mapping the first phoneme sequence to a second sequence of pronunciation phonemes in at least one second language, and generating an audio output of the phonemes in the second phoneme sequence using prosody or intonation models for the at least one second language.

According to this method, an audio output of a word in a first language can be generated by a speech synthesizing engine not having actual support for this language. Instead, the pronunciation phonemes of the word are mapped onto phonemes of at least one second language, for which the speech synthesizing engine does have support.

That a speech synthesizing engine “has support” for a specific language means that it contains digital models for intonation (pitch, gain and duration) of a given phoneme occurring in said language. These models are here referred to as “prosody models”.

Conventional speech synthesizer systems thus only support those languages that have a speech synthesizing engine developed for that particular language. According to the invention, this limitation is overcome, and the number of supported languages will be greater than the number of existing speech synthesizing engines. Typically, a speech synthesizing system according to the invention will support all languages that are supported by the speech recognition system in the same device.

The process of mapping the phonemes of one language to the phonemes of at least one second language is referred to as language morphing.

The at least one second language is advantageously selected based on the first language. In other words, the phonemes of the first language (source language) may be more suitable for mapping onto the phonemes of one particular language (target language) than another. If so, this fact should be used to select the most suitable target language for which a speech synthesizing engine exists.

The second set of phonemes may belong to a plurality of different languages, if this can improve the language morphing. It is possible that one language successfully maps a subset of the phonemes of the first language, while a different language successfully maps a different subset of the phonemes. In such a case, the speech synthesizing engines of both languages may be used to provide the best result.

The mapping is preferably performed so as to optimize the sound correspondence between the first and second set of phonemes. This will ensure that the audio output is satisfactory. In practice, the mapping may be performed by using a look-up table, based on information about such sound correspondence.

The method can also comprise processing the audio output in order to smoothen transitions between different phonemes. Such smoothening may be advantageous e.g. when the mapping has resulted in a sequence of phonemes not normally occurring in the second language, or when phonemes from different languages have been combined. The smoothening process will then improve the final result.

A second aspect of the invention relates to a speech synthesizer, comprising a text-to-phoneme module for dividing said word into a first sequence of pronunciation phonemes in said first language, processing means for mapping said first phoneme sequence to a second sequence of pronunciation phonemes in at least one second language, and a text-to-speech engine for generating an audio output of the phonemes in the second phoneme sequence using prosody models for the at least one second language. Such a speech synthesizer can be implemented in a communication device such as a mobile phone or a PDA.

### BRIEF DESCRIPTION OF THE DRAWINGS

These and other aspects of the present invention will now be described in more detail, with reference to the appended drawings showing a currently preferred embodiment of the invention.

FIG. 1 shows a communication device, equipped with a speech synthesizer according to an embodiment of the invention.

FIG. 2 shows a schematic block diagram of the speech synthesizer in FIG. 1.

FIG. 3 shows a flow chart of a method for speech synthesizing according to an embodiment of the invention.

### DETAILED DISCLOSURE OF PREFERRED EMBODIMENTS

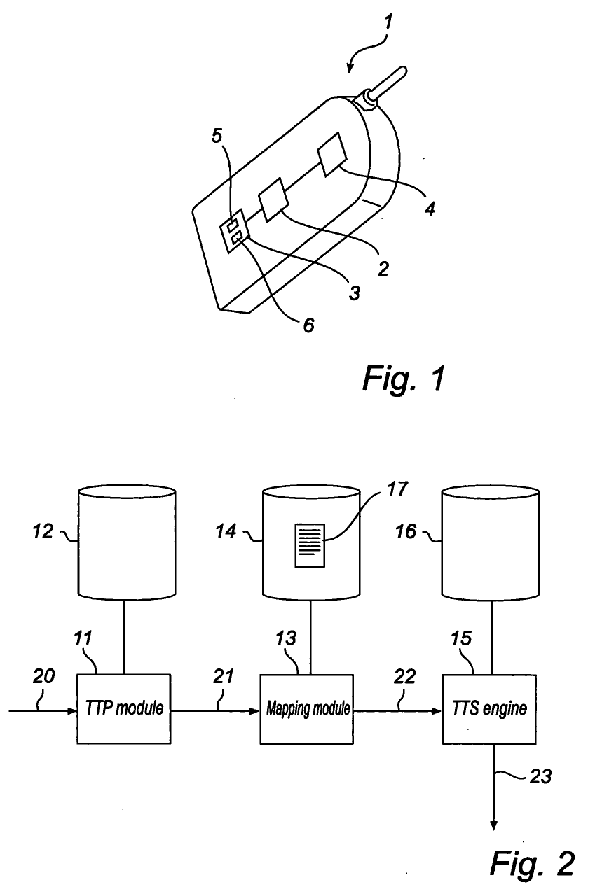

FIG. 1 shows an example of a communication device 1, here a mobile phone, having a processor 2 connected to a memory 3 and an electro-acoustic transducer, e.g. a speaker 4. The device 1 is equipped with speaker independent voice control, and for this purpose, the memory comprises software modules for realizing a speech recognition system 5 and a speech synthesizer 6.

The speech synthesizer 6 in FIG. 1 is shown in more detail in FIG. 2, here as a block diagram. It comprises a pronunciation module, or a Text-To-Phoneme (TTP) module 11 connected to a database 12 with a plurality of pronunciation models corresponding to different languages, a mapping module 13 connected to a database 14 with information relating different languages to each other, and a speech synthesis engine, or a Text-To-Speech (TTS) engine 15 connected to a database 16 with a plurality of TTS models.

The TTP module 11, the mapping module 13 and the TTS engine 15 can be embodied as computer software code portions stored in the memory 3, adapted to be loaded into and executed by the processor 2, while the databases 12, 14 and 16 can be embodied as memory areas in the memory 3, accessible from the processor 2.

The TTP module 11 can be a conventional TTP module as used in a speech recognition system. In fact, this module 11 and its database 12 can be shared by the speech recognition system 2 in the communication device 1. The TTP module 11 is capable of dividing a word in a given language into phonemes, which then can be compared to different parts of a word pronounced by the user. This is required for all languages that are to be supported by the recognition system 2, and the database 12 thus includes pronunciation models for all such languages.

The TTS engine 15 is also known per se, and is capable of generating an audio output (typically a WAV-file), based on a sequence of phonemes in a given language and prosody models (pitch, gain and duration) of these phonemes. The database 16 includes prosody models for all phonemes of the languages supported by the TTS engine 15.

It should be noted that presently the number of languages supported by conventional TTS engines is considerably smaller than the number of languages supported by conventional TTP modules. Developing a prosody model involves a significant amount of work, and research in this area is therefore slow.

The mapping module 13 is arranged to map a set of phonemes in one language to a set of phonemes in at least one different language. The database 14 can for this purpose comprise a look-up table 17, indicating which phoneme in one language that most closely corresponds to the pronunciation of a phoneme in a different language.

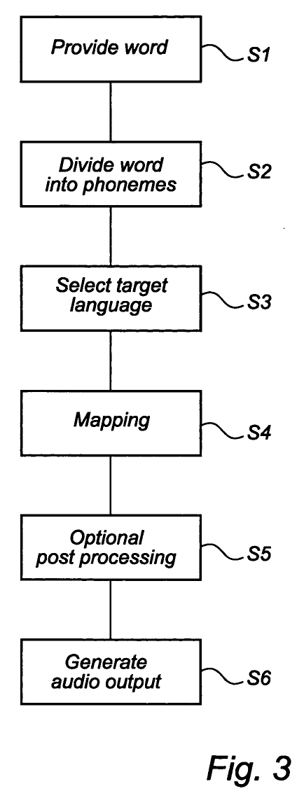

In the following, and with reference to FIG. 2 and 3, the function of the speech synthesizer 3 will be described.

First, in step S1, the TTP module 11 is provided with a word 20 to be pronounced and its language A. Typically, this word is the response of the voice recognition system to a spoken input from the user.

Then, in step S2, the TTP module 11 divides the word 20 into a sequence 21 of phonemes, by applying a pronunciation model corresponding to the language of the word 20.

Next, in step S3, the mapping module 13 selects a target language B, which is supported by the TTS engine 15. Preferably, each language supported by the TTP module is simply associated with a suitable language that is supported by the TTS engine 15, and this information can be stored in a look-up table in the database 14. It is possible that some languages are associated with a plurality of target languages, if this is considered to improve performance.

In step S4, the mapping module 13 maps the phoneme sequence 21 onto a second sequence 22 of phonemes in language B. In the case of several target languages, the phoneme sequence 22 can contain phonemes from different languages. The mapping is performed so that the best sound correspondence between the source language and target language can be maintained.

In case of identical phonemes in the source and target language, the conversion of these is trivial. Other phonemes, with clear similarities, can simply be mapped according to a predefined look-up table 17 in the database 14. Some situations, like for example when a combination of phonemes in the source language A can be represented by two or more phonemes in the target language B, are more difficult to represent in a lookup table. In such cases, or if preferred for other reasons, other methods such as neural networks, decision trees or more complex rules can be used. In case of some diftong sounds in the source/target language, rules for several phonemes can be applied (not necessary in the present example).

The prosody models used can be slightly adapted versions of the prosody models used in conventional speech engines, in order to improve the result of the language morphing.

It should be noted that if the TTS engine 15 supports the language A, steps S3 and S4 will not be effected, and sequence 22 will be identical to sequence 21.

Some combinations of phonemes resulting from the mapping step S4 do not normally occur in the language B, and may require special processing in order to improve transitions between consecutive phonemes. Any such post processing of the phoneme sequence 22 is performed in step S5.

In step S6, finally, an audio output 23 is generated by TTS engine 15 based on the (post processed) phoneme sequence 22. The audio output is in a form suitable for driving the speaker 4, e.g. in WAV format.

An example of speech synthesizing according to the above embodiment of the invention will now be described.

The word 20 received by the TTP module 11 in step S1 is here “Bernhard Völger”, and language A is German. The sequence 21 of phonemes forming the German pronunciation of the word 20 is in step S2 found to be “b-E-R-n-h-a-R-t-v-9-l-g-6”, here shown with the SAMPA (Speech Assessment methods phonetic alphabet) notation, incorporated herewith in the form of appendix.

In step S3, the target language is selected as US English. (Note that this is only an example. In reality, a TTS engine exists that supports German, and it is doubtful if German and US English would be a suitable pair of source and target languages.)

The mapping in step S4 is performed next. The phoneme sequence 22 corresponding to a pronunciation of the word 20 Bernhard Völger in US English phoneme notation is in step S4 found to be “b-E-r-n-h-A-r-t-v-@-l-g-@”, again in SAMPA notation. The following table describes the phoneme conversion for the example word, phoneme-by-phoneme, where changed phonemes are shown in bold font.

TABLE 1
Phoneme mapping for the example utterance

| | | | | | | | | | | | | | |
|---|---|---|---|---|---|---|---|---|---|---|---|---|---|
| German | b | E | R | N | h | a | R | t | V | 9 | l | g | 6 |
| US English | b | E | r | N | h | A | r | t | V | @ | l | g | @ |

This phoneme sequence is given to the TTS engine 15 provided with a US English prosody model, as if it were a native pronunciation. Hence, the TTS engine in step S5 uses its US English prosody model to produce the waveform output for the utterance.

Further examples of phoneme conversion for other German words are presented in the following tables, where again changed phonemes are shown in bold font.

TABLE 2
Phoneme mapping for further examples
Ulf Wagner

| | | | | | | | | |
|---|---|---|---|---|---|---|---|---|
| German | U | l | f | v | a: | g | N | 6 |
| US English | U | l | f | v | A: | g | N | @ |

Andreas Weber

| | | | | | | | | | | | |
|---|---|---|---|---|---|---|---|---|---|---|---|
| German | a | n | d | R | E | a | S | v | E | b | 6 |
| US English | A: | n | d | r2 | E | A: | S | v | E | b | @ |

Werner Zölls

| | | | | | | | | | |
|---|---|---|---|---|---|---|---|---|---|
| German | v | E | R | n | 6 | ts | 9 | l | S |
| US English | v | E | r2 | n | @ | tS | @ | l | S |

Hans Bayer

| | | | | | | | |
|---|---|---|---|---|---|---|---|
| German | h | a | n | s | b | aI | 6 |
| US English | h | A: | n | s | b | aI | @ |

In the above examples, the mapping is quite simple. For some languages, the mappings can be more complex, leading to phoneme clustering (one phoneme replaced with several) or phoneme deletion (several phonemes replaced with one), depending on the situation. As mentioned, some combinations of phonemes may also require post processing before the phoneme sequence 22 is supplied to the TTS engine 15. In any case, the mapping should be designed so as to achieve an audio output using a TTS engine for the target language TTS engine corresponding as closely as possible with the audio output that would have resulted if there existed a TTS engine for the first language.

### Appendix

### SAMPA

### Computer Readable Phonetic Alphabet

### SAMPA “s{mpA: Speech Assessment Methods

SAMPA (Speech Assessment Methods Phonetic Alphabet) is a machine-readable phonetic alphabet. It was originally developed under the ESPRIT project 1541, SAM (Speech Assessment Methods) in 1987-89 by an international group of phoneticians, and was applied in the first instance to the European Communities languages Danish, Dutch, English, French, German, and Italian (by 1989); later to Norwegian and Swedish (by 1992); and subsequently to Greek, Portuguese, and Spanish (1993). Under the BABEL project, it has now been extended to Bulgarian, Estonian, Hungarian, Polish, and Romanian (1996). Under the aegis of COCOSDA it is hoped to extend it to cover many other languages (and in principle all languages). On the initiative of the OrienTel project, Arabic, Hebrew, and Turkish have been added. Other recent additions: Cantonese, Croatian, Czech, Russian, Slovenian, Thai. Coming shortly: Japanese, Korean.

Unless and until ISO 10646/Unicode is implemented internationally, SAMPA and the proposed X-SAMPA (Extended SAMPA) constitute the best international collaborative basis for a standard machine-readable encoding of phonetic notation.

Note about Unicode: Recent version of the Internet Explorer and Netscape browsers are capable of handling WGL4, the subset of Unicode needed for the orthography of all the languages of Europe. Test yours by looking at this page, or download an up-to-date browser and a WGL4 font. Unicode SAMPA pages are now available with correct local orthography, for those with this capacity, for Bulgarian, Czech, Greek, Hungarian, Polish, Romanian, and Slovenian. See if your browser can cope with Unicode IPA symbols by looking at this special version of the English SAMPA page. For IPA in Unicode, see here.

SAMPA basically consists of a mapping of symbols of the International Phonetic Alphabet onto ASCII codes in the range 33 . . . 127, the 7-bit printable ASCII characters. Associated with the coding (mapping) are guidelines for the transcription of the languages to which SAMPA has been applied. Unlike other proposals for mapping the IPA onto ASCII, SAMPA is not one single author's scheme, but represents the outcome of collaboration and consultation among speech researchers in many different countries. The SAMPA transcription symbols have been developed by or in consultation with native speakers of every language to which they have been applied, but are standardized internationally.

A SAMPA transcription is designed to be uniquely parsable. As with the ordinary IPA, a string of SAMPA symbols does not require spaces between successive symbols.

SAMPA has been applied not only by the SAM partners collaborating on EUROM 1, but also in other speech research projects (e.g. BABEL, Onomastica, OrienTel) and by Oxford University Press. It is included among the resources listed by the Linguistic Data Consortium.

In its basic form SAMPA was seen as catering essentially for segmental transcription, particularly of a traditional phonemic or near-phonemic kind. Prosodic notation was not adequately developed. This shortcoming has now been remedied by a proposed parallel system of prosodic notation, SAMPROSA. It is important that prosodic and segmental transcriptions be kept distinct from one another, on separate representational tiers (because certain symbols have different meanings in SAMPROSA from their meaning in SAMPA: e.g. H denotes a labial-palatal semivowel in SAMPA, but High tone in SAMPROSA).

A proposal for an extended version of the segmental alphabet, X-SAMPA, extends the basic agreed conventions so as to make provision for every symbol on the Chart of the International Phonetic Association, including all diacritics. In principle this makes it possible to produce a machine-readable phonetic transcription for every known human language.

The present SAMPA recommendations (as devised for the basic six languages) are set out in the following table. All IPA symbols that coincide with lower-case letters of the Latin alphabet remain the same; all other symbols are recoded within the ASCII range 37 . . . 126. In this current WWW document the IPA symbols cannot be shown, but the columns indicate respectively a SAMPA symbol, its ASCII/ANSI number, the shape of the corresponding IPA symbol, the Unicode number (hex, decimal) for the IPA symbol, and the symbol's meaning or use.

| | | |
|---|---|---|
| SAMPA | IPA | Unicode |

Vowels

| | | | | |
|---|---|---|---|---|
| A | 65 | script a | 0251, 593 | open back unrounded, |
| | | | | Cardinal 5, Eng. start |
| { | 123 | æ ligature | 00E6, 230 | near-open front |
| | | | | unrounded, Eng. trap |
| 6 | 54 | turned a | 0250, 592 | open schwa, Ger. besser |
| Q | 81 | turned script a | 0252, 594 | open back rounded, Eng. |
| | | | | lot |
| E | 69 | epsilon | 025B, 603 | open-mid front |
| | | | | unrounded, C3, Fr. même |
| @ | 64 | turned e | 0259, 601 | schwa, Eng. banana |
| 3 | 51 | rev. epsilon | 025C, 604 | long mid central, Eng. |
| | | | | nurse |
| I | 73 | small cap I | 026A, 618 | lax close front |
| | | | | unrounded, Eng. kit |
| O | 79 | turned c | 0254, 596 | open-mid back rounded, |
| | | | | Eng. thought |
| 2 | 50 | ø | 00F8, 248 | close-mid front |
| | | | | rounded, Fr. deux |
| 9 | 57 | oe ligature | 0153, 339 | open-mid front rounded, |
| | | | | Fr. neuf |
| & | 38 | s.c. OE lig. | 0276, 630 | open front rounded |
| U | 85 | upsilon | 028A, 650 | lax close back rounded, |
| | | | | Eng. foot |
| } | 125 | barred u | 0289, 649 | close central rounded, |
| | | | | Swedish sju |
| V | 86 | turned v | 028C, 652 | open-mid back |
| | | | | unrounded, Eng. strut |
| Y | 89 | small cap Y | 028F, 655 | lax [y], Ger. hübsch |

Consonants

| | | | | |
|---|---|---|---|---|
| B | 66 | beta | 03B2, 946 | voiced bilabial |
| | | | | fricative, Sp. cabo |
| C | 67 | ç, c-cedilla | 00E7, 231 | voiceless palatal |
| | | | | fricative, Ger. ich |
| D | 68 | [symbol] , eth | 00F0, 240 | voiced dental |
| | | | | fricative, Eng. then |
| G | 71 | gamma | 0263, 611 | voiced velar fricative, |
| | | | | Sp. fuego |
| L | 76 | turned y | 028E, 654 | palatal lateral, It. |
| | | | | famiglia |
| J | 74 | left-tail n | 0272, 626 | palatal nasal, Sp. año |
| N | 78 | eng | 014B, 331 | velar nasal, |
| | | | | Eng. thing |
| R | 82 | inv. s.c. R | 0281, 641 | vd. uvular fric. or |
| | | | | trill, Fr. roi |
| S | 83 | esh | 0283, 643 | voiceless |
| | | | | palatoalveolar fricative, |
| | | | | Eng. ship |
| T | 84 | theta | 03B8, 952 | voiceless dental |
| | | | | fricative, Eng. thin |
| H | 72 | turned h | 0265, 613 | labial-palatal |
| | | | | semivowel, Fr. huit |
| Z | 90 | ezh (yogh) | 0292, 658 | vd. palatoalveolar |
| | | | | fric., Eng. measure |
| ? | 63 | dotless? | 0294, 660 | glottal stop, Ger. |
| | | | | Verein, also Danish stød |

Length, stress and tone marks

| | | | | |
|---|---|---|---|---|
| : | 58 | colon | 02D0, 720 | length mark |
| ″ | 34 | vertical stroke | 02C8, 712 | primary stress |
| % | 37 | low vert. str. | 02CC, 716 | secondary stress |
| \grave{ } | 96 | (see note) | | falling tone |
| ′ | 39 | (see note) | | rising tone |

Note: The SAMPA tone mark recommendations were based on the IPA as
it was up to 1989-90. Since then, however, the IPA has changed its
symbols for falling and rising tones. These SAMPA tone marks may now
be considered obsolete, having in practice been superseded by the
SAMPROSA proposals.

Diacritics
(shown with another symbol as an example)

| | | | | |
|---|---|---|---|---|
| =n | 60 | inferior stroke | 0329, 809 | syllabic consonant, |
| | | | | Eng. garden |
| O˜ | 126 | superior tilde | 0303, 771 | nasalization, Fr. bon |

The Phonemic Notation of Individual Languages

These pages provide a brief outline of the phonemic distinctions in various languages: Arabic, Bulgarian, Cantonese, Czech, Croatian, Danish, Dutch, English, Estonian, French, German, Greek, Hebrew, Hungarian, Italian, Norwegian, Polish, Portuguese, Romanian, Russian, Spanish, Swedish, Thai, Turkish.

Extensions

These pages provide extensions of the basic segmental SAMPA: SAMPROSA (prosodic), X-SAMPA (other symbols, mainly segmental).

UCL Phonetics and Linguistics home page, University College London home page.

A utility: Instant IPA in Word—converts SAMPA to IPA.

For queries please contact John Wells by e-mail or at
Department of Phonetics and Linguistics, University College London, Gower Street, London WC1E 6BT.
.+44 171 380 7175
Last revised Apr. 28, 2003
http://www.phon.ucl.ac.uk/home/sampa/home.htm

1. A method for speech synthesis of a word (20) in a first language (A), comprising:
dividing said word (20) into a first sequence (21) of pronunciation phonemes in said first language (A),
mapping said first phoneme sequence (21) to a second sequence (22) of pronunciation phonemes in at least one second language (B), and
generating an audio output (23) of the phonemes in said second phoneme sequence (22) using prosody models for said at least one second language (B).

2. The method according to claim 1, further comprising selecting said at least one second language (B) in dependence of said first language (A).

3. The method in claim 1, wherein said second sequence (22) of phonemes belong to a plurality of different languages.

4. The method according to claims 1, wherein said mapping is performed so as to optimize the sound correspondence between said first and said second sequence (21, 22) of phonemes.

5. The method according to claim 1, wherein said mapping includes using a look-up table.

6. The method in claim 1, wherein said prosody models are provided by a text-to-speech (TTS) engine (11) adapted for said at least one second language (B).

7. The method according to claim 1, further comprising smoothening transitions between different phonemes in said second phoneme sequence (22).

8. A computer program product, loadable into memory (3) of a computer (2), said computer program product comprising computer code portions (11, 13, 15) for performing the method according to claim 1 when executed by said computer.

9. The computer program product in claim 8, stored on a computer readable medium (3).

10. A speech synthesizer (6) for speech synthesis of a word (20) in a first language (A) comprising:
a pronunciation module (11) for dividing said word (20) into a first sequence (21) of pronunciation phonemes in said first language (A),
processing means (13) for mapping said first phoneme sequence (21) to a second sequence (22) of pronunciation phonemes in at least one second language (B), and
a speech synthesis engine (15) for generating an audio output (23) of the phonemes in said second phoneme sequence (22) using prosody models for said at least one second language (B).

11. The speech synthesizer in claim 10, wherein said processing means (13) has access to a look-up table (17).

12. The speech synthesizer in claim 11, wherein said look-up table is stored in a memory (3).

13. The speech synthesizer in claim 10, further comprising post processing means, for smoothening transitions between different phonemes in said second phoneme sequence (22).

14. A communication device comprising a speech synthesizer (6) according to claim 10.

15. The communication device in claim 14, further comprising a voice recognition system (5).
